(19) United States
(12) Patent Application Publication
(10) Pub. No.: US 2015/0174671 A1
(43) Pub. Date: Jun. 25, 2015

(54) Cutting tool, especially a drilling or milling tool

(71) Applicant: Jakob Lach GmbH & Co. KG, Hanau (DE)

(72) Inventor: Eugen MAURER, Ober-Moerlen (DE)

(21) Appl. No.: 14/483,816

(22) Filed: Sep. 11, 2014

(30) Foreign Application Priority Data
Sep. 13, 2013 (DE) 102013110123.2
Dec. 12, 2013 (DE) 102013114792.5

(51) Int. Cl. B23B 51/06; B23C 5/06

(52) U.S. Cl. CPC B23B 51/06; B23C 5/06; B23B 2250/12; B23B 2251/02; B23B 2251/50; B23C 2210/16; B23C 2250/12

(57) ABSTRACT

The invention pertains to a cutting tool for material-removing machining of materials, comprising a shaft (12) with a tool head (16) having a cutting blade (70). For the effective cooling of the tool blades, the shaft (12) has a single coolant supply channel (26) running in the longitudinal direction of the shaft and a single coolant return channel (28) running in the longitudinal direction and the tool head (16) has a single flow channel (78) connecting the coolant supply channel (26) to the coolant return channel (28) which is thermally coupled to the tool blades (70).

The invention pertains to a cutting tool, especially a drilling or milling tool for material-removing machining of materials, comprising a shaft with a tool head having a cutting blade. Moreover, the invention pertains to a cutting tool such as a drilling or milling tool for material-removing machining of materials with a plurality of tool carriers having tool blades, such as hollow drills or face milling cutters, especially face milling cutters, wherein the tool blades are supplied with coolant via coolant supply channels and coolant return channels, which are fashioned in the tool carrier and connected fluidically through a coolant distribution system to a single coolant supply channel and a single coolant return channel, which extend in an adapter connected to the tool carrier and are connected to a coolant reservoir.

A cutting tool of the known kind is described in WO 95/29030 A1. The tool comprises a shaft which can be driven in rotation about a longitudinal axis, especially one made of solid carbide. At a working end of the shaft there are arranged tool blades and at another coupling end of the shaft there is provided a coupling area for connecting to the drive spindle of a machine tool. The tool furthermore has channels running alongside each other through the shaft in essentially the longitudinal direction and emerging in its working end in order to carry fluids from the side of the coupling end to the working end. The channels form a coolant loop of a closed coolant circuit, wherein the exit openings at the working end are joined together by an externally fluid-tight and top-mounted wearing part for their spatial connection.

Several channels, especially a pair of channels, emerge at the working end into the free surface area of a tool blade, especially a drilling tool blade, and their exit ends are covered by closure plate which jointly spans over them and maintains a distance from the neighboring tool blade, allowing fluid to flow only between the exit ends.

In the tool of the prior art, several channels such as a pair of channels emerge at the working end into the free surface area of a tool blade so that a sufficient cooling of the tool blade itself is not assured. One pair of channels is provided for each free surface area of a tool blade, so that the setup of the shaft and the covering of the exit ends with several fluid-tight top-mounted wearing parts is time-consuming.

Based on this, the problem of the present invention is to modify a tool of the kind mentioned above so that an effective cooling of tool blades, especially diamond tool blades, is ensured with a simple fabrication.

The problem is solved according to a first ingenious notion in that the shaft has a single coolant supply channel running in the longitudinal direction of the shaft and a single coolant return channel running in the longitudinal direction of the shaft and the tool head has a single flow channel connecting the coolant supply channel to the coolant return channel which is thermally coupled to the tool blades.

The solution of the invention is distinguished from the prior art in that all tool blades can be cooled with only a single coolant supply channel and coolant return channel in the shaft, such as a drill shaft, and a single flow channel in the tool head, such as a drill head.

In one preferred embodiment, the single flow channel is thermally coupled to the tool blades arranged in the tool head.

A simple fabrication of the flow channel is characterized in that the single flow channel is configured as at least one radial borehole or a segment of the at least one radial borehole in a toolbox of the tool head. In order to accomplish an effective thermal coupling, i.e., to ensure that the flow channel runs near the tool blades, the single flow channel is formed from radially extending segments in the form of radial boreholes, which extend from an outer radial surface of the tool head in the direction of a center axis and pass into each other in the area of the center axis.

For the connection of the flow channel, radial segments are coupled via channels running in the longitudinal direction of the shaft to the coolant supply channel and the coolant return channel.

To improve the cooling properties, the radially extending channel segments have cross section enlargements in the form of cooling ribs along their length. The coolant channel or the coolant channel segments can be closed at the margin with a closure element, such as a headless screw.

In one embodiment of the cutting tool with internal suction of shavings, the shaft is configured as a hollow cylindrical drill shaft, while the coolant supply channel and the coolant return channel is formed in a wall of the drill shaft in the longitudinal direction, preferably as a deep borehole.

Another preferred embodiment is characterized in that the tool head is configured as a drill head and removably connected to the drill shaft, as by screwing on, the coolant supply channel and the coolant return channel end in an annular working end of the hollow cylindrical drill shaft and are coupled by exit openings of channel segments of the drill head running in the longitudinal direction.

In the case of a shaft made from solid material as a drill shaft, the single coolant supply channel and the single coolant return channel run in the solid material, while the tool head as a drill head is removably connected to the drill shaft and can be connected by a bearing surface to a working end of the drill shaft, and the flow channel connecting the coolant supply channel to the coolant return channel is arranged in the bearing surface of the drill head.

Another preferred embodiment is characterized in that the flow channel in the bearing surface of the drill head is formed preferably by milling and is adapted to the structure and location of the tool blades, and the flow channel is preferably S-shaped in the case of a two-bladed tool head.

When the drill shaft is made of solid material, the flow channel can be sealed by a sealing element such as a sealing lip arranged in a groove in a surface of the working end.

To prevent a twisting of the drill head relative to the drill shaft, one end face of the working end of the drill shaft has a toothing, which cooperates with a corresponding toothing in a bearing surface of the drill head.

For the supplying of coolant, the hollow cylindrical drill shaft is connected to an adapter, while a connection channel runs in the adapter and can be coupled via the coolant supply channel and the coolant return channel to a coolant reservoir.

Another preferred embodiment is characterized in that the drill shaft has a tool coupling, the coolant supply channel and the coolant return channel each emerging by an exit opening in a circumferential surface of the tool coupling, and a preferably two-way rotary passthrough can be mounted on the tool coupling, with radially extending channels that are fluidically coupled to the exit openings of the coolant supply channels and the coolant return channels.

Another ingenious embodiment of the invention pertains to a cutting tool, such as a drilling tool or milling tool for the material-removing machining of materials with a tool carrier having a plurality of tool blades, such as a hollow drill or milling head or face milling cutter, wherein the tool blades are supplied with coolant via coolant supply channels and via coolant return channels, which are fashioned in the tool carrier and are fluidically coupled via a coolant distribution system to a single coolant supply channel and a single coolant return channel, which run in an adapter connected to the tool carrier and are coupled to a coolant reservoir.

For the simple distribution of coolant from a coolant reservoir to a plurality of tool blades of a rotating cutting tool, the coolant distribution system has an annular coolant supply distribution channel, which is coupled at its inlet to the single coolant supply channel and at its outlet to the plurality of coolant supply channels, and the coolant distribution system has a coolant return distribution channel, which is coupled at its inlet with the plurality of coolant return channels and at its outlet with the single coolant return channel.

A preferred embodiment is characterized in that the coolant distribution system is configured as a coolant transfer ring, comprising an annular disk, having on the forward flow side the coolant forward distribution channel in the form of a groove and a return flow side in which the coolant return distribution channel is in the form of a groove, and the channels are coupled via exit and/or return openings to the coolant return channels and/or coolant supply channels.

Furthermore, the annular grooves arranged in the coolant transfer ring are sealed by annular sealing elements and arranged between a flange connection between a hollow cylindrical drill shaft and the adapter.

A fixation of the sealing elements relative to the coolant transfer ring occurs by pins, which are received twistproof in an encircling flange of the adapter.

Another preferred embodiment of a face milling cutter is characterized in that the coolant distribution system is arranged in a surface of the platelike milling head or face milling cutter, comprising an annular coolant supply distribution channel, which is coupled at the inlet end to the single coolant supply channel and at the outlet end to the plurality of coolant supply channels, and an annular coolant return distribution channel, which is coupled at the inlet end to the plurality of coolant return channels and at the outlet end to the single coolant return channel, which lies in an adapter.

An especially simple embodiment is characterized in that the coolant supply distribution channel and the coolant return distribution channel are each configured as an annular encircling groove in the surface of the milling head, while sealing elements in the form of O-rings lie between the channels and the distribution channels and the sealing elements are sealed fluid-tight by a cover.

Further details, benefits and features will emerge not only from the claims, the features found there—in themselves and/or in combination—but also from the following description of preferred sample embodiments shown in the drawing.

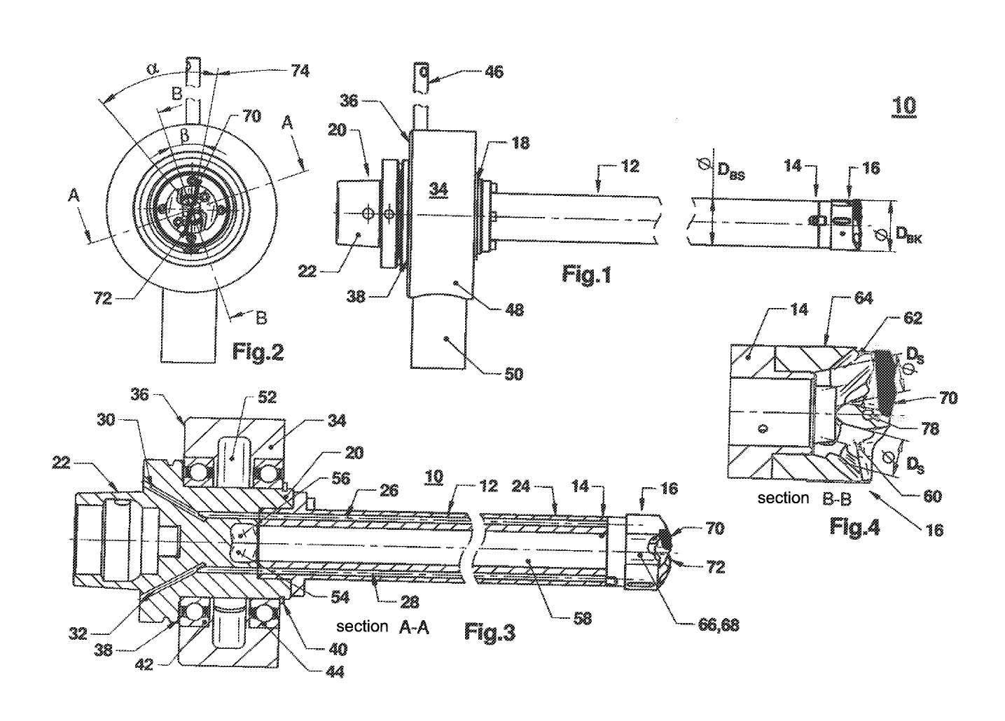

FIG. 1 a side view of a first embodiment of a cutting tool in the form of a drilling tool with internal shaving suction and internal cooling,

FIG. 2 a bottom view of the drilling tool of FIG. 1,

FIG. 3 of the drilling tool of FIG. 1 along sectioning line A-A of FIG. 2,

FIG. 4 a cross sectional representation of a drill head of the drilling tool of FIG. 1 along a sectioning line B-B in FIG. 2,

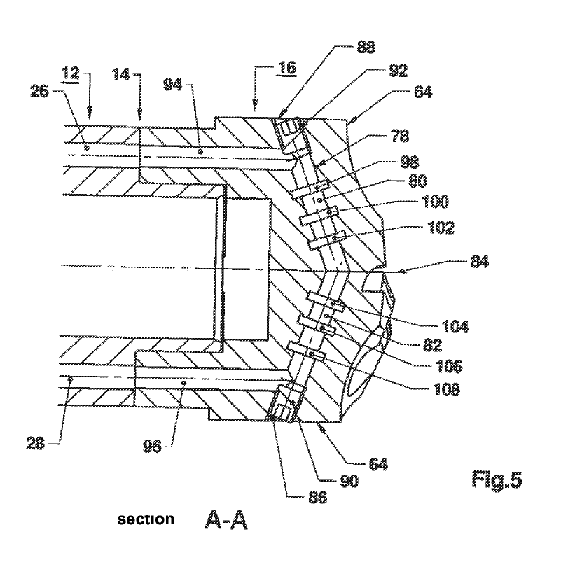

FIG. 5 a cross sectional representation of the drill head along the sectioning line A-A of FIG. 2,

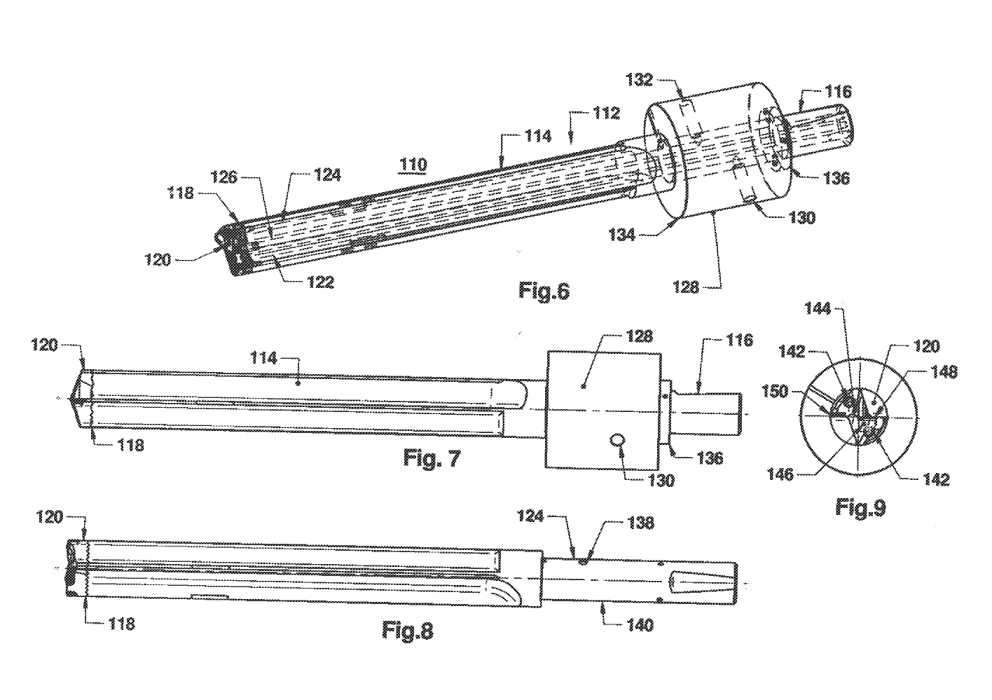

FIG. 6 a perspective view of a second embodiment of a cutting tool in the form of a drilling tool with drill shaft and removably fastened drill head with internal cooling,

FIG. 7 a side view of the drilling tool of FIG. 6 in 0° position with rotary passthrough,

FIG. 8 a side view of the drill shaft per FIG. 7 in 90° position,

FIG. 9 a bottom view of the drill head per FIG. 7,

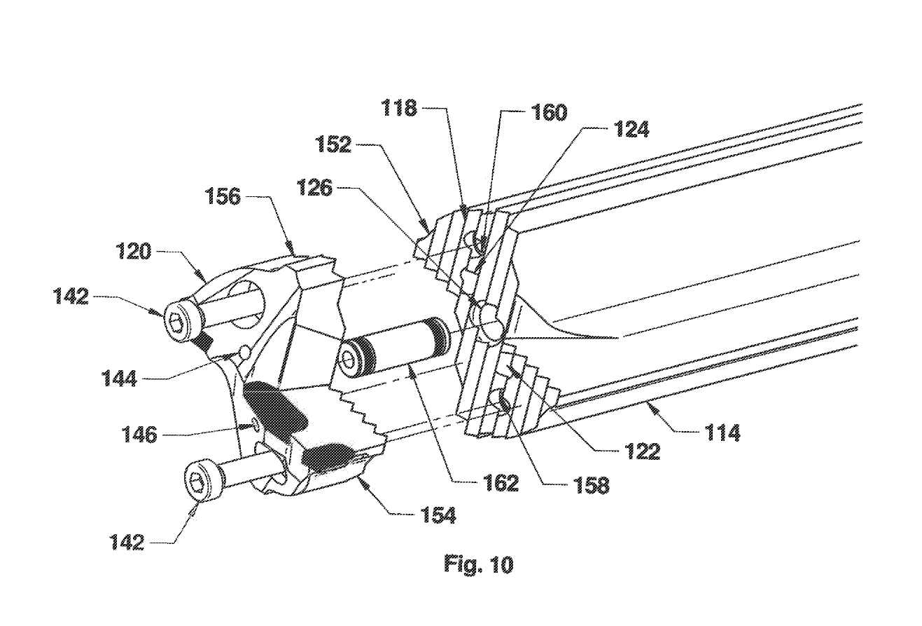

FIG. 10 an exploded view of the drill shaft end with drill head,

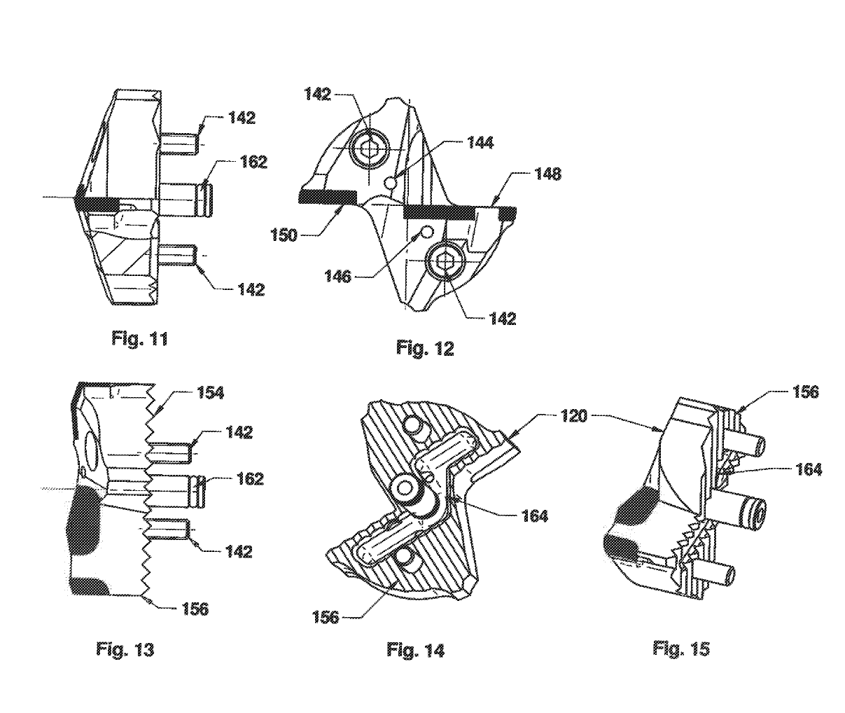

FIG. 11 a side view of the drill head in 0° position, partly sectioned,

FIG. 12 a bottom view of the drill head in 0° position,

FIG. 13 a side view of the drill head in 90° position,

FIG. 14 a perspective top view of the drill head with coolant flow channel,

FIG. 15 a perspective side view of the drill head,

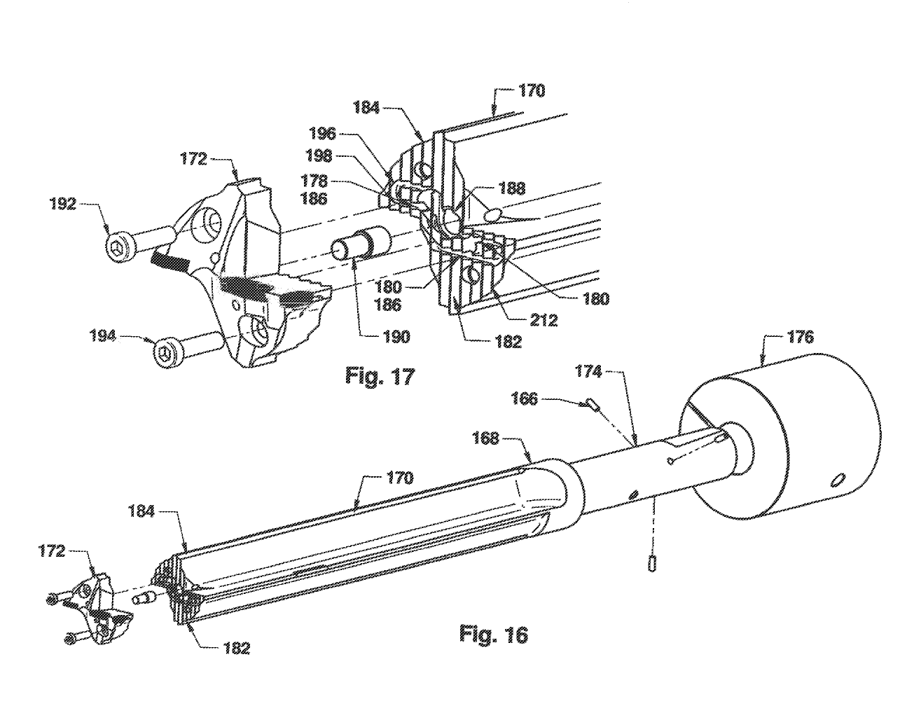

FIG. 16 a perspective view of a third embodiment of a cutting tool in the form of a drilling tool with drill shaft, drill head, and rotary passthrough,

FIG. 17 a perspective exploded view of a working end of the drill shaft with drill head,

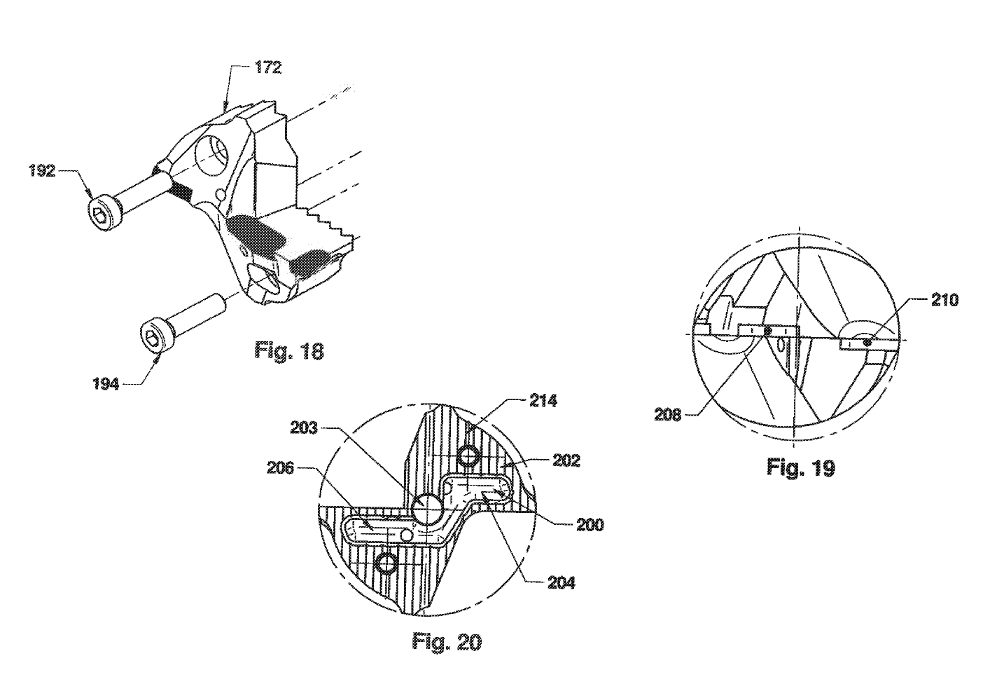

FIG. 18 a perspective front view of the drill head,

FIG. 19 a bottom view of the drill head,

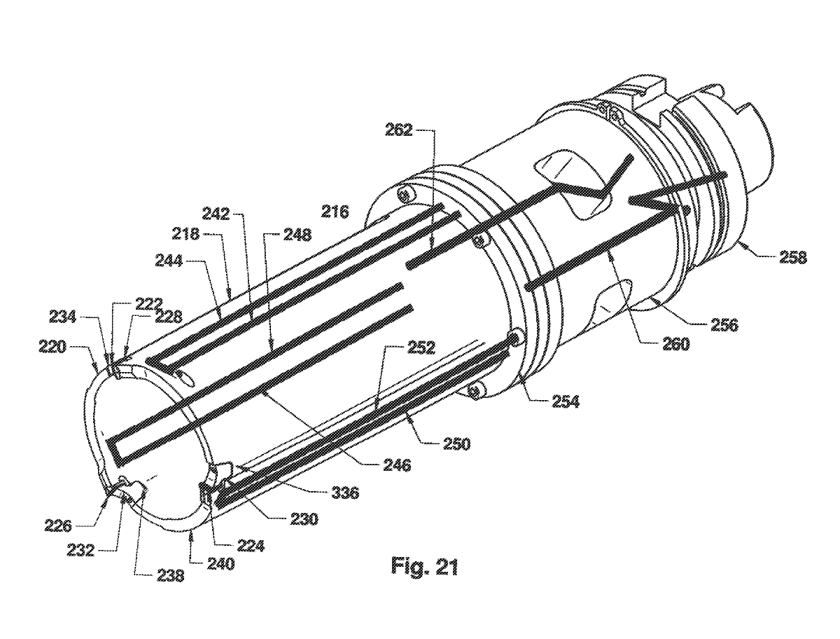

FIG. 20 a top view of the drill head with coolant flow channel,

FIG. 21 a perspective view of a fourth embodiment of a cutting tool in the form of a hollow drill with internal shaving suction and internal cooling,

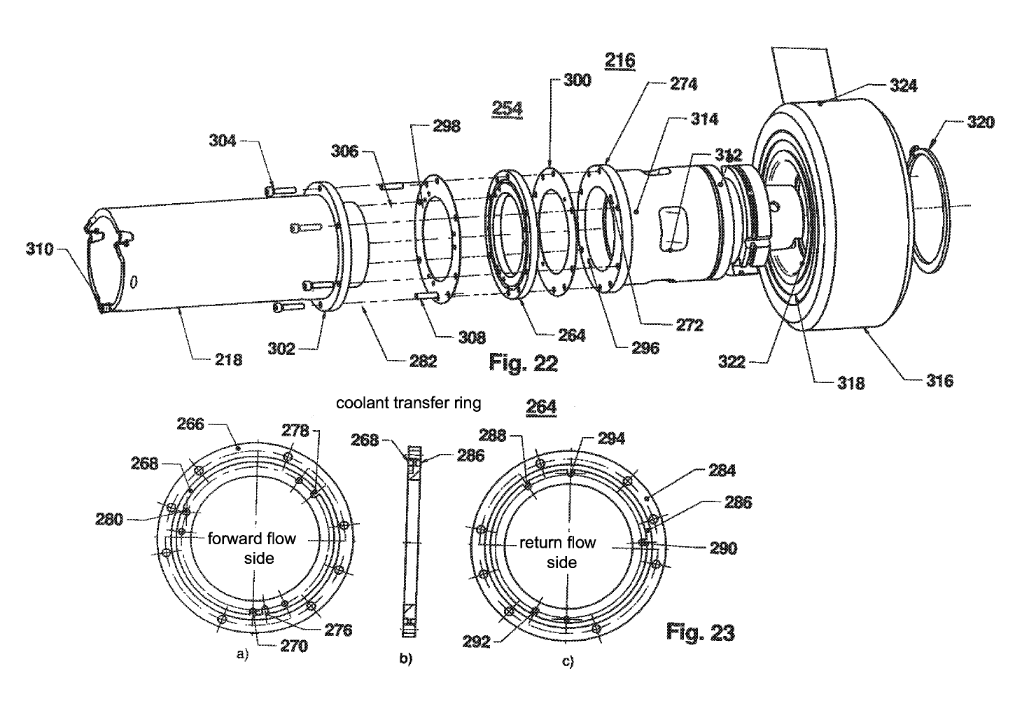

FIG. 22 a perspective exploded view of the hollow drill of FIG. 21,

FIG. 23 a, b, c a coolant transfer ring in front view, side view and rear view,

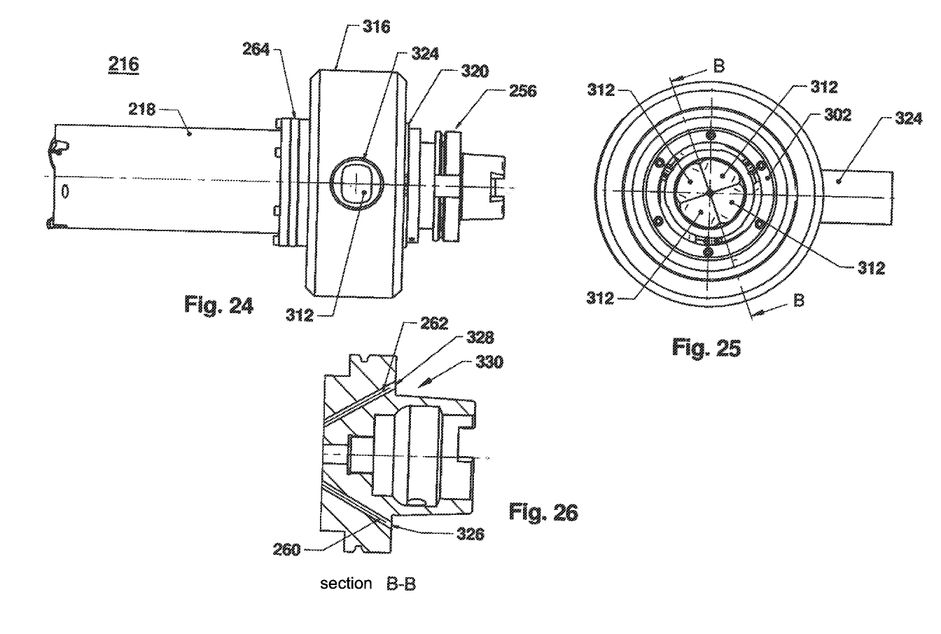

FIG. 24 a side view of the hollow drill per FIG. 22,

FIG. 25 a bottom view of the hollow drill per FIG. 22,

FIG. 26 a cross sectional representation of a segment of an intermediate adapter along sectioning line B-B per FIG. 25,

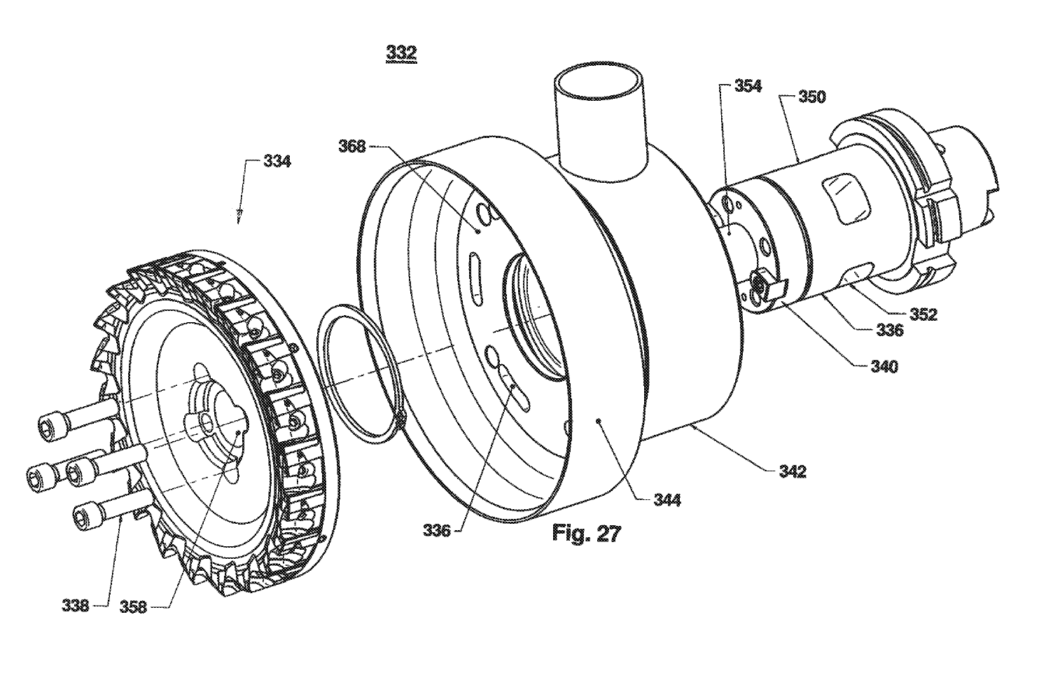

FIG. 27 a perspective exploded view of a fifth embodiment of a cutting tool in the form of a face milling cutter with shaving suction and internal cooling,

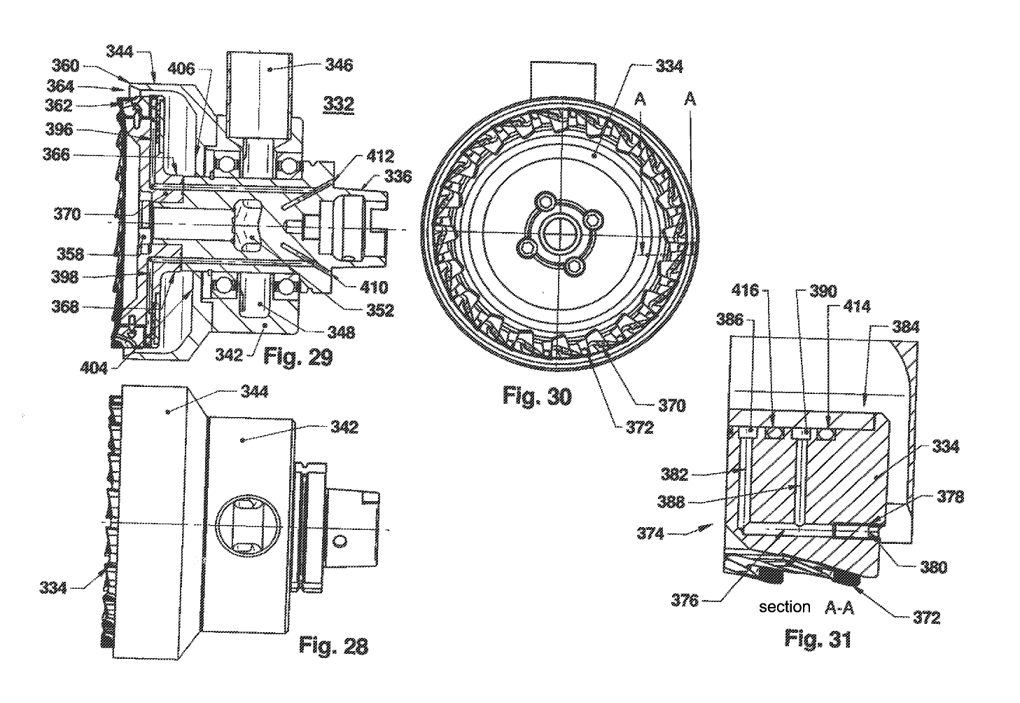

FIG. 28 a side view of the face milling cutter per FIG. 27,

FIG. 29 a cross sectional representation of the face milling cutter of FIG. 28,

FIG. 30 a bottom view of the face milling cutter of FIG. 28,

FIG. 31 a cross sectional representation of a partial segment of the platelike milling head along a sectioning line A-A of FIG. 30 and

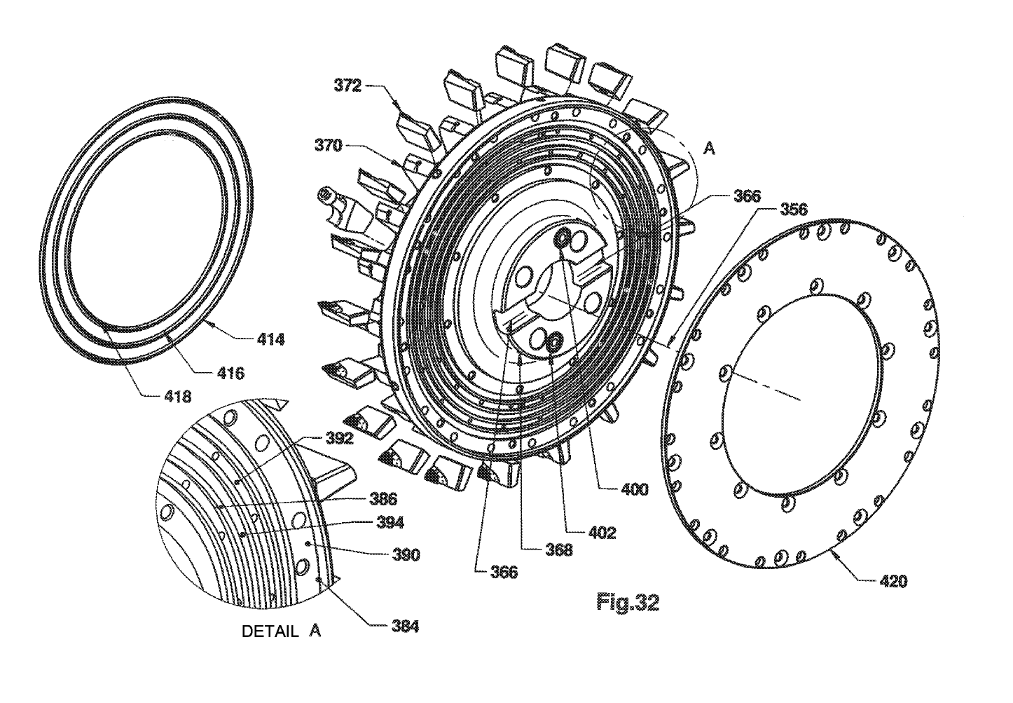

FIG. 32 a perspective exploded view of a milling head of the face milling cutter of FIG. 27.

FIG. 1 shows a first embodiment of a cutting tool in the form of a drilling tool 10 with internal shaving suction and internal cooling. The drilling tool 10 comprises a drill shaft 12, at whose working end 14 is secured a drill head 16, such as by screwing on. The drill shaft 12 is connected via a flange 18 to an adapter 20, which has a shaft 22 according to the HSK (hollow shaft cone standard) at the machine tool end. For the cooling of the tool head 16, there are arranged in a wall 24 of the internal hollow drill shaft 12 a coolant supply channel 26 running in longitudinal direction of the drill shaft 12 and a coolant return channel 28 running in the longitudinal direction of the hollow shaft. The coolant supply channel 26 and the coolant return channel each emerge into a connection channel 30, 32, which runs in the adapter 20 and connects the coolant supply channel 26 and the coolant return channel 28 to a coolant reservoir.

Furthermore, there is mounted on the adapter 20 a suction ring 34, which bears by a side surface 36 against a flange 38 of the adapter and is secured by a fixation element such as a snap ring 40 on the adapter 20 in the axial direction. The suction ring 34 is mounted across bearings 42, 44 on a cylindrical surface of the adapter 20 and can be locked against twisting by a pin 46. From a peripheral marginal surface 48 there extends a suction tube 50, which is fluidically coupled to an encircling annular channel 52 inside the suction ring. This empties through suction openings 54, 56 in the cylindrical wall of the adapter 20 into a suction channel 58 of the internally hollow shaft 12. The suction channel 58 empties into suction openings 60, 62, which are arranged in the drill head 16 for the suctioning of shavings.

In the embodiment shown here, the drill head 16 has recesses 66, 68 as transfer channels in its outer wall 64, running in the longitudinal direction of the drill head 16 and emptying into the suction openings 60, 62 in the end face. Thanks to the transfer channels 66, 68, intake air drawn in through the intermediate space formed between borehole and recess 66, 68 is conducted specifically past the tool blades 70, 72 of the drill head and effectively carries away any shavings or heat occurring there. The drill head 16 has a diameter D_{BK} which is larger than the diameter D_{BS} of the drill shaft 12. Preferably, the diameter D_{BK} of the drill head can be around 59 mm, while the diameter D_{BS} of the drill shaft is around 50 mm

The drill head 16 has an outer wall 64, which determines the diameter D_{BK} of the drill head. The tool blades 70, 72 at the end face extend diagonally along a radial line 74. Recesses 66, 68 as transfer channels are worked into the outer wall 64 in the longitudinal direction, emptying into the suction openings 60, 62. The recesses 66, 68 extend along the circumference at an angle α, starting from the radial line 74, the angle α being around 45°. The center points of the suction openings 60, 62 are arranged at an angle of around 30° relative to the radial line 74 in the direction of rotation of the drilling tool.

As already mentioned above, a coolant supply channel 26 and a coolant return channel 28 in the form of a deep borehole are made in the wall 24 of the inner hollow drill shaft 12 for the cooling of the tool head 16. The channels 26, 28 empty into a flow channel 78 forming a cooling space extending in the drill head 16, which connects the coolant supply channel 26 to the coolant return channel 28. The flow channel 78 runs in the drill head 16 adjoining the tool blades, having diamond material for example, in order to cool them effectively.

FIG. 5 shows the drill head 16 as well as the working end 14 of the drill shaft 12 in cross sectional representation. The flow channel 78 in the sample embodiment depicted is formed in segments from radially extending segments 80, 82 as boreholes, which extend from the outer surface 64 of the drill head in the direction of the center axis 84 and pass over into each other in the region of the center axis 84. An opening 86, 88 of the radial segments 80, 82 at the outer wall side is closed by a closure element 90, 92, such as a headless screw, which extends in the radial direction in a threading. The radial segments 80, 82 of the flow channel 78 are each coupled by channels 94, 96 running in the longitudinal direction to the coolant supply channel 26 and the coolant return channel 28.

To improve the cooling action, the radially extending channel segments 80, 82 have cross sectional enlargements 98, 100, 102; 104, 106, 108 along the course of the channel, which are formed by the “cooling fins”. The channels 80, 82 are arranged such that they are placed in optimal thermal coupling, preferably immediately beneath the tool blades 70, 72.

FIGS. 6 to 15 show a second embodiment of a cutting tool in the form of a drilling tool 110 such as a solid drill with internal cooling. The drilling tool 110 comprises a base body 112 with a drill shaft 114 and a tool coupling 116. At a working end 118 of the drill shaft 114 there is a drill head 120 removably fastened, as by screwing on. For the cooling of the drill head 120, there are fashioned in the drill shaft 114, which consists of solid material, preferably a hard metal, a coolant supply channel 122 and a coolant return channel 124 in the longitudinal direction. Preferably, the coolant supply channel and the coolant return channel are produced as a deep borehole in the drill shaft 14.

Moreover, for the flushing of the drill head with air there is fashioned an air flushing channel 126 in the drill shaft 114. On the tool coupling 116 there is rotationally mounted a two-way rotary passthrough 128, having radial channels 130, 132, which extend from an outer wall 134 radially to the inside and are fluidically coupled to the coolant supply channel 124 and the coolant return channel 122. The two-way rotary passthrough 128 is secured by means of a securing ring 136 on the tool coupling 116.

As shown in FIG. 8, the coolant return channel 124 empties into an exit opening 138 with an outer surface 140 of the tool coupling 116 and is fluidically coupled to the radial borehole 132 in the two-way rotary passthrough.

FIG. 9 shows a top view of the drill head 120, which is connected by means of fasteners such as screws 142 to the working end 118 of the drill shaft 114, such as by screwing on. The flushing air channel 126 empties into openings 144, 146, which are arranged in free surfaces of the drill head, i.e., behind the tool blades 148, 150 in the direction of rotation. The tool blades 148, 150 are made from a diamond material and are joined to the drill head 120, such as by soldering.

FIG. 10 shows a connection between the drill shaft 114 and the drill head 120 in a perspective exploded view. The drill head 120 is secured by the screws 142 to the working end 118 of the drill shaft 114. One end face 152 of the working end 118 has a toothing, which matches up with a corresponding toothing 154 of a bearing surface 156 of the drill head. In the end face 152 of the drill shaft there are seats 158, 160 for the fasteners 142. The flushing air channel 126 emerges in the end face 152 and is coupled via a connection tube 162 to air channels 164, 166 which run in the drill head and emerge in free surfaces of the drill head. Furthermore, FIG. 14 shows that both the coolant return channel 124 and the coolant supply channel 122 emerge in the end face 152.

FIGS. 14 and 15 show the bearing surface 156 of the drill head 120, there being fashioned in the bearing surface 156 a flow channel 164 forming a cooling space, which connects the coolant supply channel 122 to the coolant return channel 124. The flow channel 164 is profiled with a milling cutter and adapted to the structure and position of the diamond blades 148, 150. In the case of a two-bladed tool, one course of the coolant channel 164 is configured such that it is essentially S-shaped, so that an optimal thermal coupling with the tool blades 148, 150 is assured. Preferably, the flow channel 164 is worked into the bearing surface 156 of the drill head 120 by a milling process.

FIG. 16-20 show a third embodiment of a cutting tool in the form of a drilling tool 166 as a solid drill, with a base body 168, comprising a drill shaft 170 with drill head 172 as well as a tool coupling 174, on which a two-way rotary passthrough 176 can be placed. Inside the drill shaft 170 running in the longitudinal direction is a coolant supply channel 178 as well as a coolant return channel 180, each of them emerging in an end face 182 of a working end 184 of the drill shaft 170 by exit openings 186.

Furthermore, there is provided a flushing air channel 188, which is coupled by a coupling element 190 in the form of an air transfer tube to air exit openings which run in the drill head 172. The drill head 172 can be connected via fastening elements such as screws 192, 194 to the working end 184 of the drill shaft 170.

The drilling tool 166 differs from the embodiment of the drilling tools 110 in that a groove 196 is provided in the end face 182 for a sealing element 198. The sealing element 198 matches up with a flow channel 200, which is arranged in a bearing surface 202 of the drill head 176 and seals it off. The flow channel 200 has an essentially S-shaped course. Contrary to the embodiment per drilling tool 110, the flow channel 200 does not extend through a center axis 203 of the drill shaft 170, so that the coupling element 190 does not transect the flow channel. The flow channel 200 has lengthwise segments 204, 206, which run parallel or essentially parallel to and in thermal coupling with the tool blades 208, 210, as shown in FIG. 19 in top view. For the mechanical fixation of the drill head 172 at the working end 182 of the drill shaft 170, both the working end 184 of the drill shaft and the bearing surface 202 of the drill head have a toothing 212, 214, which mesh with each other in the assembled state and prevent a twisting of the drill head 172 relative to the drill shaft 170.

A fourth embodiment of a cutting tool involves a drilling tool in the form of a hollow drill 216 with internal cooling and internal shaving suction. The hollow drill 216 shall be described below with reference to FIGS. 21 to 26. A tubular drill shaft 218 has at its working end 220 diamond blades 222, 224, 226 distributed evenly along its circumference, each of them being secured by means of a fixation element 228, 230, 232 in a recess 234, 236, 238 in a side wall 240 of the drill shaft 218.

For the cooling of the diamond blades 222, 224, 226, a pair of channels made up of a coolant supply channel 242, 246, 250 and a coolant return channel 244, 248, 252 run in the wall 240 of the internally hollow drill shaft (hollow drill body) 218.

The drill shaft 218 is joined by a connection flange 254 to an adapter 256, which can be connected to a machine tool with coolant reservoir 258. In the adapter 256 there is arranged a single coolant supply channel 216 and a single coolant return channel 262. The coolant channels 260, 262 are connected to a coolant reservoir (not shown).

FIG. 22 shows an exploded view of the hollow drill 216. The hollow drill 210 has an ingenious invented coolant distribution system 264, which is preferably integrated in the connection flange 254. The coolant distribution system distributes the coolant supplied via the single coolant supply channel 216 to the coolant supply channels 242, 246, 250 located in the drill shaft 218 a conducts the coolant returning via the coolant return channels 244, 248, 252 to the single coolant return channel 262.

FIG. 23 shows the coolant transfer ring 264 in a front view, side view and rear view. A forward flow side 266 has an annular coolant forward flow distribution channel 268 in the form of a groove, which can be coupled via an inlet opening 270 to an inlet opening 272 of the coolant supply channel 260, which emerges in an encircling flange 274 of the adapter 256. Furthermore, exit openings 276, 278, 280 branch off from the annular groove 268, which can be coupled with the coolant supply channels 242, 246, 250 which emerge in an encircling margin 282 of the drill shaft 218 to form a flow connection.

At a return side 284 of the coolant transfer ring there is fashioned a coolant return distribution channel 286 in the form of a groove, which can be coupled via return openings 288, 290, 292 to the coolant return channels 244, 248, 252 which emerge in the end face 282 of the drill shaft 218. Moreover, the distribution channel 286 can be connected via an opening 294 to an exit opening 296 of the single coolant return channel 262.

The forward flow side 266 and the return flow side 284 of the coolant transfer ring 264 are each sealed with an annular seal 298, 300, which in the installed state can be clamped between the encircling flange 274 of the adapter 256 and an encircling flange 302 of the drill shaft 218 together with the coolant transfer ring 264 by means of fastening elements 304 such as screws.

For the securing of the annular seals 298, 300 in relation to the coolant transfer ring 264 there are pins 306, 308 provided, which pass through the coolant transfer ring and the seals and are secured at the their ends in the flanges 272, 302.

As already mentioned, the drilling tool 216 described is a hollow drill with internal cooling and internal shaving suction. The suctioning occurs via an internal suction channel 310 of the drill shaft 318 and via suction openings 312 which are arranged in a side wall 314 of the adapter 256 and fluidically connected to the internal suction channel 310 of the drill shaft 218.

On the cylindrical surface 314 of the adapter 256 is mounted a suction ring 316 by means of ball bearings 318. The ball bearings 318 are received in bearing seats of the suction ring 316, with a first ball bearing resting against the encircling flange 272 of the adapter 256 and a second ball bearing of the suction ring 316 being secured in position by means of a securing element 320 such as a snap ring.

The suction channel 310 of the drill shaft 218 emerges into the suction openings 312, which in turn emerge into a fluidically coupled annular gap 322 situated on the inside of the suction ring 316, the annular gap 322 being fluidically coupled to a suction tube 324 for suctioning away the shavings.

FIG. 24 shows the hollow drill 216 in the assembled state, the suction ring 316 being placed on the adapter 256 and secured by means of the fixation element 320.

FIG. 25 shows a bottom view of the hollow drill 216 with the suction openings 312, which emerge into the annular gap 322 of the suction ring 316.

FIG. 26 shows a cross sectional representation of an end segment of the adapter 256 along the sectioning line B-B of FIG. 25. The single coolant supply channel 260 and the coolant return channel 262 have exit openings 326, 328 which emerge in an encircling shoulder 330 of the adapter 256 and which can be connected via a connector (not shown) to a coolant reservoir.

FIGS. 27 to 32 show a fifth embodiment of a cutting tool in the form of a tool 332 which is configured with an ingenious invented internal and/or external shaving suctioning and an ingenious invented internal cooling.

The milling tool 332 comprises a platelike face milling cutter 334, which can be coupled by means of an adapter 336 to a machine tool. The face milling cutter 334 can be connected via connection elements 338 such as screws to a flange 340 of the adapter 336. On the adapter 336 is rotationally mounted a suction ring 342. The suction ring 342 adjoins a hoodlike cover 344, in which the milling head 334 is accommodated.

FIG. 28 shows a side view of the milling tool 332 in the assembled state, the face milling cutter 334 being arranged in the suction hood 344 of the suction ring 342.

FIG. 29 shows a side view of the milling tool 332 in cross sectional representation. The suction ring 342 has a suction tube 346, which is fluidically coupled to an annular gap 348 encircling the suction ring 342. In an outer wall 350 of the adapter there are arranged suction openings 352, which on the one hand emerge into the annular gap 348 and on the other hand are coupled to an internal suction channel 354, which extends along the lengthwise axis 356 of the adapter 336. The suction channel 354 emerges into a suction opening 358, which is arranged at the center of the platelike face milling cutter 334 and by which shavings building up inside the face milling cutter 334 are suctioned away.

Independently of this, the milling tool 332 has an ingenious invented external shaving suctioning, wherein shavings are suctioned away via an encircling suction gap 364 formed between an encircling edge 360 of the suction hood 344 and an external encircling edge 362 of the face milling cutter 334. The shavings are then suctioned away via suction openings 366 into the annular gap 348 of the suction ring 342. The suction openings 366 are arranged as oblong holes in a side wall of the suction hood 344 and emerge in connection channels of an end face of the suction ring 342, at which the suction hood 344 is fastened to the side wall. The connection channels join the suction openings 366 to the annular gap 348 of the suction ring 344.

An ingenious notion of the invention pertains to the design of an internal cooling for the face milling cutter 334.

FIG. 30 shows a bottom view of the face milling cutter 334. The face milling cutter 334 according to FIG. 27 is shaped platelike and has seats 370 for diamond blades 372 on its margin.

FIG. 31 shows a cross sectional representation of a margin segment of the face milling cutter 334 in the region of a seat 370 for a diamond blade 372 along sectioning line A-A of FIG. 30. Each diamond blade 372 is coordinated with a coolant channel 374. The coolant channels 374 are coupled via a coolant distribution system 375 to a coolant supply channel and coolant return channel. The coolant channel 374 consists of a first segment 376 running parallel to an end face of the face milling cutter 334, which extends from the circumferential edge 362 of the face milling cutter 334 in the radial direction toward the center. An exit opening of the channel segment 376 can be closed by means of a closure element 380. From the first channel segment 376 there extends a second channel segment 382 to a coolant forward distribution channel 386 running in a ring in one surface 384 of the milling head 334. Furthermore, a third channel segment 388 extends to a coolant return distribution channel 390 running in a ring likewise in the surface 384.

The course and the arrangement of the distribution channels in the surface 384 of the face milling cutter 334 shall be explained in detail with respect to FIG. 32. FIG. 32 shows the face milling cutter 334 in an exploded view. In the surface 384 of the face milling cutter 334 are formed the coolant forward distribution channel 386 and the coolant return channel 390 as grooves. From the annular channels 386, 390 there extend the channel segments 382, 388, which emerge by exit ends 392 and 394 into the annular grooves 386, 390 and extend to the channel segment 376 in the longitudinal direction along the lengthwise axis 356. The channels 386, 390 are connected by radially extending supply channels 396, 398, which run inside a wall of the face milling cutter, to exit openings 400, 402 which emerge into the flange 370. The exit openings 400, 402 in the assembled state of FIG. 29 are connected to channels 404, 406 extending in the longitudinal direction in the adapter 336, which emerge in an encircling shoulder 408 of the adapter 336 through exit openings 410, 412 and can be connected to a coolant reservoir.

For the sealing of the annular grooves 386, 390 there are sealing elements 414, 416, 418 provided between the grooves 386, 390. The grooves 386, 390 and the sealing elements in the form of O-rings 414, 416, 418 are covered with an annular sealing 420, which is screwed together with the surface 384 of the face milling cutter 334.

1. Cutting tool (10, 110, 166) for material-removing machining of materials, comprising a shaft (12, 114, 170) with tool head (16; 120; 172) having a tool blade (70, 72; 148, 150; 208, 210),
characterized in that
the shaft (12; 114; 170) has a single coolant supply channel (26; 122; 178) running in the longitudinal direction of the shaft and a single coolant return channel (28; 124, 180) running in the longitudinal direction and the tool head (16; 120; 172) has a single flow channel (78; 164; 200) connecting the coolant supply channel (26; 122; 178) to the coolant return channel (28; 124, 180) which is thermally coupled to the tool blades (70, 72; 148, 150; 208, 210).

2. Cutting tool according to claim 1,
characterized in that
the single flow channel (78; 164; 200) is thermally coupled to the tool blades (70, 72; 148, 150; 208, 210) arranged in the tool head (16; 120; 172).

3. Cutting tool according to claim 1,
characterized in that
the single flow channel (78) is configured as at least one radial borehole or a segment of the at least one radial borehole in a toolbox of the tool head (16).

4. Cutting tool according to claim 1,
characterized in that
the single flow channel (78) is formed from radially extending segments (80, 82) in the form of radial boreholes, which extend from an outer radial surface (64) of the tool head (16) in the direction of a center axis (84) and pass into each other in the area of the center axis (84).

5. Cutting tool according to claim 4,
characterized in that
the radial segments (80, 82) of the flow channel (78) are coupled via channels (94, 96) running in the longitudinal direction of the shaft (12) to the coolant supply channel (26) and the coolant return channel (28).

6. Cutting tool according to claim 4,
characterized in that
the radially extending channel segments (80, 82) have cross section enlargements (98, 100, 102; 104, 106, 108) in the form of cooling ribs along their length.

7. Cutting tool according to claim 5,
characterized in that
the flow channel (78) or the channel segments (80, 82) can be closed at the margin with a closure element (86, 88), such as a headless screw.

8. Cutting tool according to claim 1,
characterized in that
the shaft (12) is configured as a hollow cylindrical drill shaft, and the coolant supply channel (26) and the coolant return channel (28) is formed in a wall (24) of the drill shaft (12) in the longitudinal direction, preferably as a deep borehole.

9. Cutting tool according to claim 1,
characterized in that
the tool shaft (16) is configured as a drill head and removably connected to the drill shaft (12), as by screwing on, the coolant supply channel (26) and the coolant return channel (28) end in an annular working end (14) of the hollow cylindrical drill shaft (12) and are coupled by exit openings of the channel segments (94, 96) of the drill head (16) running in the longitudinal direction.

10. Cutting tool according to claim 1,
characterized in that
the single coolant supply channel (122, 178) and the single coolant return channel (124, 180) run in a shaft made of solid material as a drill shaft (114, 170), the tool head as a drill head is removably connected to the drill shaft (114, 170) and can be connected by a bearing surface (156, 202) to a working end (118, 182) of the drill shaft (114, 170), and the flow channel (164, 200) connecting the coolant supply channel (122, 178) to the coolant return channel (124, 180) is arranged in the bearing surface (156, 202) of the drill head (120, 176).

11. Cutting tool according to claim 10,
characterized in that
the flow channel (164; 200) in the bearing surface (156, 202) of the drill head (120, 176) is formed preferably by milling and is adapted to the structure and location of the tool blades, and/or the flow channel (164; 200) is preferably S-shaped in the case of a two-bladed tool head.

12. Cutting tool according to claim 1,
characterized in that
the flow channel (200) is sealed by a sealing element (198) such as a sealing lip arranged in a groove (196) in a surface (180) of the working end (182).

13. Cutting tool according to claim 10,
characterized in that
one end face (152, 182) of the working end (118, 180) of the drill shaft (114, 170) has a toothing, which cooperates with a corresponding toothing (154, 212, 214) in a bearing surface (156; 200) of the drill head (120, 172).

14. Cutting tool according to claim 1,
characterized in that
the hollow cylindrical drill shaft (12) is connected to an adapter (20), while a connection channel (30, 32) runs in the adapter and can be coupled via the coolant supply channel (26) and the coolant return channel (28) to a coolant reservoir.

15. Cutting tool according to claim 1,
characterized in that
the drill shaft (114; 170) has a tool coupling (116; 174), the coolant supply channel (122; 178) and the coolant return channel (124; 180) each emerging by an exit opening in a circumferential surface of the tool coupling (116, 174), and a preferably two-way rotary passthrough (128, 176) can be mounted on the tool coupling (116; 174), with radially extending channels (130, 132) that are fluidically coupled to the exit openings of the coolant supply channels and the coolant return channels.

16. Cutting tool (216, 332), such as a drilling tool or milling tool for the material-removing machining of materials with a tool carrier (218; 334) having a plurality of tool blades (222, 224, 226; 372), such as a hollow drill (218) or face milling cutter (334), especially a face milling cutter, wherein the tool blades are supplied with coolant via coolant supply channels (242, 246, 250; 282) and via coolant return channels (244, 248, 252; 388), which are fashioned in the tool carrier (218; 334) and are fluidically coupled via a coolant distribution system (264; 375) to a single coolant supply channel (260; 406) and a single coolant return channel (262; 404), which run in an adapter (256; 336) connected to the tool carrier (218; 324) and are coupled to a coolant reservoir, characterized in that
the coolant distribution system (264; 375) has an annular coolant supply distribution channel (268; 386), which is coupled at its inlet to the single coolant supply channel (260; 406) and at its outlet to the plurality of coolant supply channels (242, 246, 250; 382), and the coolant distribution system has a coolant return distribution channel (286), which is coupled at its inlet with the plurality of coolant return channels (244, 248, 252; 388) and at its outlet with the single coolant return channel (262; 406).

17. Cutting tool according to claim 16,
characterized in that
the coolant distribution system (264) is configured as a coolant transfer ring, comprising an annular disk, having on the forward flow side (266) the coolant forward distribution channel (268) configured in the form of a groove and a return flow side (284) in which the coolant return distribution channel (286) is configured in the form of a groove, and the channels (268, 286) are coupled via exit and/or return openings (276, 278, 280; 288, 290, 292) to the coolant return channels and/or coolant supply channels.

18. Cutting tool according to claim 17,
characterized in that
the annular grooves (268, 286) arranged in the coolant transfer ring (264) are sealed by annular sealing elements (298, 300) and arranged between a flange connection between a hollow cylindrical drill shaft (218) and the adapter (256).

19. Cutting tool according to claim 18,
characterized in that
a fixation of the sealing elements (298, 300) relative to the coolant transfer ring (284) occurs by pins (306, 308), which are received twistproof in an encircling flange (272) of the adapter (256).

20. Cutting tool according to claim 17,
characterized in that
the coolant distribution system is arranged in a surface (384) of the platelike face milling cutter (334), comprising an annular coolant supply distribution channel (386), which is coupled at the inlet end to the single coolant supply channel (406) and at the outlet end to the plurality of coolant supply channels (382), and an annular coolant return distribution channel (390), which is coupled at the inlet end to the plurality of coolant return channels (388) and at the outlet end to the single coolant return channel (404), which lies in an adapter (408).

21. Cutting tool according to claim 20,
characterized in that
the coolant supply distribution channel (386) and the coolant return distribution channel (390) are each configured as an annular encircling groove in the surface (384) of the face milling cutter (334), while sealing elements (414, 416, 418) in the form of O-rings lie between the channels (386, 390) and the distribution channels (386, 390) and the sealing elements (414, 416, 418) are sealed fluid-tight by a cover (420).
